(19) United States
(12) Patent Application Publication
(10) Pub. No.: US 2020/0340903 A1
(43) Pub. Date: Oct. 29, 2020

(54) SENSOR APPARATUS FOR EXAMINING A SAMPLE GAS VOLUME

(71) Applicant: HELLA GmbH & Co. KGaA, LIPPSTADT (DE)

(72) Inventors: Uwe Röben, ZETEL (DE); Jürgen PALLOKS, WESTERSTEDE (DE); Karsten Schumacher, OLDENBURG (DE); Joachim Funke, OTZBERG (DE)

(21) Appl. No.: 16/857,363

(22) Filed: Apr. 24, 2020

(30) Foreign Application Priority Data
Apr. 24, 2019 (DE) 10 2019 110 590.0

(51) Int. Cl. G01N 15/06; G01N 1/22; B60H 1/00

(52) U.S. Cl. CPC G01N 15/06; G01N 2015/0693; B60H 1/00735; G01N 1/2205

(57) ABSTRACT

A sensor apparatus for examining a sample gas volume, particularly for capturing the particulate matter content of a sample gas volume, includes at least one measuring chamber to accommodate the sample gas that is to be analysed, and at least one sample gas feed allocated to the measuring chamber and with at least one sample gas discharge allocated to the measuring chamber, in which it is provided as essential for the invention that at least one cleaning gas feed is allocated to the measuring chamber, that the cleaning gas feed is connected to the measuring chamber via at least one cleaning gas inlet, that a condensation area is allocated to the cleaning gas feed, and that the condensation area is arranged in front of the cleaning gas inlet of the cleaning gas feed into the measuring chamber.

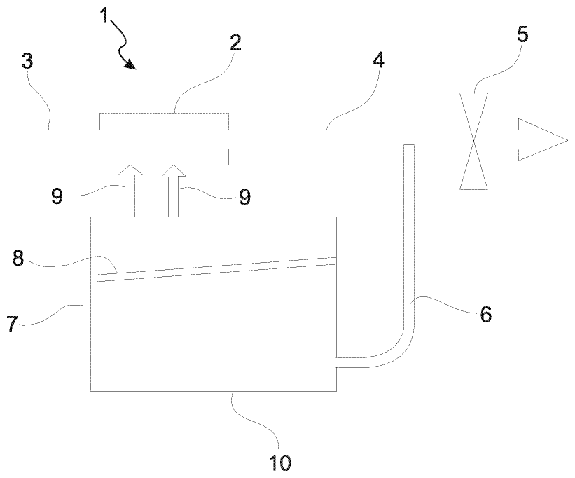

### FIELD OF DISCLOSURE

The invention relates to a sensor apparatus for examining a sample gas volume, particularly for capturing the particulate matter content of a sample gas volume, with a measuring chamber to accommodate the sample gas that is to be analysed, with at least one sample gas feed allocated to the measuring chamber and with at least one sample gas discharge allocated to the measuring chamber.

### BACKGROUND

Sensor apparatuses for examining gas volumes, particularly for capturing particulate matter, are used in many application areas, in the automotive industry for example. With a sensor apparatus, for example, it is possible to analyse the particulate matter content of a sample gas volume or a sample gas volume flow. For this purpose, the sensor apparatus includes at least one measuring chamber, in which the sample gas volume can be analysed. For example, the sample gas may be the air surrounding a motor vehicle, which is to be examined with regard to its particulate matter content in order to make a decision can be made as to whether or not it is appropriate to ventilate the interior of the vehicle with the ambient air. The sample gas volume may be fed into the measuring chamber through a sample gas feed, particularly a sample gas feed line. After the examination, the sample gas volume may be siphoned out of the measuring chamber through a sample gas discharge. For the examination, the sensor apparatus may be equipped with a measuring apparatus, which may be a laser light source, for example, from which laser light is directed through the sample gas volume in the measuring chamber, and further optical elements such as photodiodes, for example. The laser light is scattered and reflected by particles in the sample gas volume. The light which is scattered and reflected by the particles can be captured by means of optical elements, by photodiodes, for example. Conclusions may be drawn about the particle concentration, for example, in particular about the particulate matter concentration in the sample gas volume examined, from the scattered light which is captured.

One difficulty with operating a sensor apparatus is that dust particles contained in the sample gas volume to be analysed or the gas stream to be analysed may accumulate in the measuring chamber, and may contaminate the optical elements which are needed to capture the scattered light. A gas stream with a clean gas, for example, i.e., a gas that contains no particles, such as clean air, may be used to flush the measuring chamber, for example. For this purpose, a cleaning gas feed with its own ventilation unit is usually needed exclusively for this purpose. For example, the sample gas volume provided as cleaning gas may be drawn from the area surrounding the sensor device and cleaned before it is used. However, a particularly difficult aspect of purifying ambient air for use as a cleaning gas is that the ambient air may be charged with moisture, which may condense inside the measuring chamber. In this context, condensation particularly of atmospheric moisture in the measuring chamber can significantly detract from the measurement accuracy.

### SUMMARY

The object underlying the invention is to suggest a sensor apparatus of the type described in the introduction, in which condensation of moisture from the cleaning gas in the measuring chamber is prevented.

This object is solved with a sensor apparatus having the features of claim 1. Further developments and advantageous variations thereof are described in the subclaims.

In a sensor apparatus for examining a sample gas volume, particularly for capturing the particulate matter content of a sample gas volume, having at least one measuring chamber for accommodating the sample gas to be examined, having at least one sample gas feed allocated to the measuring chamber and having at least one sample gas discharge allocated to the measuring chamber, it is provided as essential for the invention that at least one cleaning gas feed is allocated to the measuring chamber, that the cleaning gas feed is connected to the measuring chamber via at least one cleaning gas inlet, that a condensation area is attached to the cleaning gas feed, and that the condensation area is arranged in front of the cleaning gas inlet of the cleaning gas feed in the measuring chamber.

The sensor apparatus is equipped with at least one measuring chamber, in which the sample gas volume for examination is examined. For the examination, a sample gas volume to be examined is introduced in the form of a gas stream from the area surrounding a motor vehicle in which the sensor apparatus is used, for example, through a sample gas feed into the measuring chamber. The sample gas feed may be a pipe, for example. For example, a sample gas stream is produced by a ventilation system and is propelled through the measuring chamber. The sample gas volume to be examined is analysed in the measuring chamber. After the examination in the measuring chamber, the analysed sample gas volume is transported to a sample gas discharge. The analysis of the sample gas stream in the measuring chamber may take place continuously. The sample gas discharge may be a pipe which discharges the analysed sample gas volume back into the environment. In order to prevent particles from the sample gas stream accumulating in the measuring chamber and/or to clean the measuring chamber, particularly to clean the optical elements in the measuring chamber, a cleaning gas is introduced into the measuring chamber through a cleaning gas feed. In this context, the cleaning gas feed may be designed as a pipe which is connected to the measuring chamber via a cleaning gas inlet. Through the cleaning gas inlet, the cleaning gas is introduced into the measuring chamber in such a way that a gas stream is formed from the cleaning gas, and is created between the sample gas stream and the optical elements that are to be protected. The cleaning gas stream thus functions as a kind of protective layer between the elements that are to be protected and the particle-charged sample gas stream. In order to prevent the moisture in the cleaning gas from condensing in the measuring chamber, in other words to ensure that the cleaning gas fed into the measuring chamber is as dry as possible, a condensation area is allocated to the cleaning gas feed. The condensation area is arranged in front of the cleaning gas inlet of the cleaning gas feed into the measuring chamber. The laser light source arranged in the measuring chamber gives off heat during operation. In the same way, inherent heat is produced during operation of the ventilation system. The condensation area is preferably disposed at a distance from the measuring chamber and the ventilation system due to the pipes of the cleaning gas feed, with the result that the temperature in the condensation area is lower than in the region of the measuring chamber. Thus, condensation of the atmospheric moisture that is in the air to be cleaned is encouraged in the condensation area. After passing through the condensation area, the air which is now dry is fed through the cleaning gas inlets into the measuring chamber as a cleaning gas.

In a further development of the invention, at least one filtering device is allocated to the cleaning gas feed in order to clean the gas which is transported through the cleaning gas feed, the filtering device has a filter housing and a flat filter, and the condensation area is arranged inside the filter housing. In order to enable ambient air for example, or previously examined sample gas to be used as the cleaning gas, the sensor apparatus may have a filtering device for purifying the gas which is intended use. The gas charged with particles may be introduced into the filtering device, the gas charged with particles is passed through the filtering device, wherein its burden of particles is removed, so that the purified gas may be used as a cleaning gas. The filtering device has a filter housing, in which at least one filter of flat design is disposed. The filter may be for example a filter made from nonwoven material or the like. The condensation area is arranged inside the filter housing, so that atmospheric moisture present in the air that is to be purified can condense in the filter housing, and thus does not reach the measuring chamber. Condensation of the atmospheric moisture in the filter housing does not negatively impact the measurement in the measuring chamber, and purified, dry cleaning air may be fed into the measuring chamber.

In a further development of the invention, the condensation area is embodied as a condensation surface, wherein the condensation surface is embodied as an interior wall of the filter housing. The condensation area for condensing atmospheric moisture which is present in the gas intended for use as cleaning gas, is embodied as a condensation surface. The condensation surface may be embodied as a flat area which in particular has a lower temperature than the other regions of the sensor apparatus, so that condensation of the atmospheric moisture on the condensation surface is encouraged. The condensation surface is embodied as an interior wall of the filter housing, with the result that the condensation takes place inside the filter housing and after passing through the filter housing the gas which is fed into the filter housing is available for use as a purified, dry cleaning gas.

In a further development of the invention, at least a first wall of the filter housing has at least one gas feed line to the measuring chamber, at least one second wall of the filter housing has at least one inlet of the cleaning gas feed, at least one filter is arranged between the first and the second wall, and the condensation surface is separated from the gas feed line to the measuring chamber by the filter. The filter housing has one gas-conducting connection with the measuring chamber and one gas-conducting connection with the cleaning gas feed. In this context, a first wall of the filter housing has a gas feed line to the measuring chamber, that is to say a cleaning gas inlet, for introducing the cleaning gas into the measuring chamber. There may be a pipe connection between the filter housing, particularly between the wall of the filter housing and the measuring chamber, for example. Moreover, the filter housing has a second wall, into which the cleaning gas feed flows through an inlet. The flat filter is arranged between the inlet of the cleaning gas feed and the gas feed line to the measuring chamber in such a way that gas which is introduced into the filter housing must unavoidably pass through the filter before it can pass into the measuring chamber. In addition, the condensation surface is arranged on the side of the filter facing away from the measuring chamber. The condensation surface is thus located on the dirty side of the filter, that is to say on the side of the filter on which the particles are deposited. The passage of atmospheric moisture through the filter is made still more difficult, thereby encouraging condensation on the condensation surface, that is to say in the dirty area of the filter.

In a further development of the invention, the flat filter slopes downwards relative to the condensation surface starting from the inlet of the cleaning gas feed towards the filter housing. A flat filter is arranged inside the filter housing. The gas feed line running from the filter housing into the measuring chamber is separated from the inlet of the cleaning gas feed into the filter housing by the filter. Consequently, gas that passes into the filter housing must unavoidably pass through the filter before it can enter the measuring chamber. The filter is substantially of flat design and has a downward slope relative to an inner surface of the housing which forms the condensation surface, which slope extends from the inlet of the cleaning gas feed into the filter housing. Consequently, the filter is at a greater distance from the condensation surface in the area of the cleaning gas inlet than in the area of the condensation surface facing away from the inlet. This in turn has the effect of reducing the flow cross section between the filter and the condensation surface in flow-optimised manner, and additional space is available in the area of the inlet for the condensate which is deposited on the condensation surface.

In a further development of the invention, at least one filter is designed to be permeable to gases and impermeable to liquids. At least one filter, which is arranged inside the filter housing, is designed with pores of such a size that the filter is impermeable to fluids in the non-gaseous form. Thus, the filter presents an additional barrier through which liquid that condenses out of the gas which is fed into the filter chamber cannot pass. In this way, liquid is prevented entirely from getting into the measuring chamber.

In a further development of the invention, the condensation surface is arranged on the side of the filter housing facing away from the measuring chamber. The filter housing has gas feed lines to the measuring chamber. The outer wall of the filter housing, which includes at least one, preferably two gas feed lines, is arranged to face towards the measuring chamber. The condensation surface is embodied as an interior wall of the filter housing, which wall faces away from the measuring chamber. The condensation surface may for example be embodied as an interior wall of the filter housing which is arranged opposite the wall of the filter housing that includes the gas feed lines to the measuring chamber. As a result, the interior wall of the filter housing that functions as the condensation surface is arranged at a distance from the measuring chamber, and therefore also at a distance from the inherent heat radiated for example by the laser light source and the ventilation system. Accordingly, the condensation surface has a lower temperature than the measuring chamber, so that condensation is encouraged on the condensation surface and thus in an area of the filter housing which will not interfere with the measurement.

In a further development of the invention, at least one cleaning gas inlet is connected to the measuring chamber in such a way that the cleaning gas stream is directed between the sample gas stream and the optical elements arranged inside the measuring chamber. The measuring chamber contains optical elements, such as photodiodes or lenses for example, which are used to measure the particulate matter content in the sample gas volume. In order to protect these optical elements from soiling by the particles contained in the sample gas stream, the cleaning gas stream is introduced into the measuring chamber in such a way that the cleaning gas stream is directed between the optical elements and the particle-bearing sample gas stream like a kind of protective layer. For this purpose, for example flow guide elements or the like may be used. In particular, the cleaning gas stream may be introduced in the area of the interior wall of the measuring chamber so that the sample gas stream is sheathed in portions. Thus, the cleaning gas stream functions as a sheathing gas stream enveloping at least portions of the sample gas stream, so that a precipitation of particles out of the sample gas stream onto the optical elements is prevented.

A further aspect of the invention relates to a motor vehicle with a sensor apparatus according to the invention, wherein the vehicle is equipped with an air conditioning system for regulating the atmosphere in the vehicle interior, wherein the sensor apparatus has at least one measuring chamber for accommodating a sample gas to be examined, at least one sample gas feed allocated to the measuring chamber, and at least one sample gas discharge allocated to the measuring chamber, in which it is provided as essential to the invention that the sensor apparatus has a condensation surface and that the condensation surface is arranged in the area of the air-conditioned interior.

The sensor apparatus has a measuring chamber, in which the sample gas volume to be examined is examined. For this purpose, the sensor apparatus may have a measuring device. The measuring device may include for example a laser light source and optical elements such as photodiodes. In the measuring chamber, the sample gas volume is illuminated with laser light, wherein the laser light is scattered and reflected by particles present in the sample gas volume. The light that is scattered and reflected by the particles can be captured. Conclusions may be drawn about the particle concentration, for example, in particular about the particulate matter concentration in the sample gas volume examined, from the scattered light captured. In order to clean the measuring chamber, in particular in order to clean the optical elements inside the measuring chamber, a cleaning gas is introduced into the measuring chamber via a cleaning gas feed. In this context, the cleaning gas feed may be embodied for example as a pipe which is connected to the measuring chamber via a gas feed line. In order to purify the gas intended for use as cleaning gas, the sensor apparatus may have a filter housing with at least one filter disposed therein, wherein the gas to be purified passes through the filter before entering the measuring chamber. In order to prevent moisture present in the cleaning gas from being able to condense in the measuring chamber, in other words in order to ensure that the gas fed into the measuring chamber is as dry as possible, a condensation area is allocated to the cleaning gas feed. The condensation area may be an interior wall of the filter housing. In such a case, the filter housing is arranged in the interior of the vehicle in such a manner that the outer wall whose inside, interior wall functions as a condensation surface, is arranged to face towards the air-conditioned interior of the vehicle. Heat is radiated by the laser light source and by ventilation systems. Due to the inherent heat of the laser light source and the ventilation system, the sample gas stream is exposed to a higher temperature in the measuring chamber than on the interior wall of the filter housing which is arranged to face the air-conditioned interior of the vehicle. The sensor apparatus may also have a thermal insulation in the area of the measuring chamber, that is to say in the area of the sample gas feed. The difference in temperature between the measuring chamber and the sample gas feed to the filter housing has the effect of encouraging condensation of atmospheric moisture in the filter housing in the region of the condensation surface provided for this purpose. The condensation surface in the filter housing is arranged on the side of the filter where the particles are precipitated, that is to say on the dirty side of the filter. In this way, moisture is prevented from getting into the measuring chamber by the cleaning gas. The arrangement of the sensor apparatus with a filter housing facing towards the air conditioned interior of the vehicle has the effect of encouraging condensation of the atmospheric moisture in the filter housing, before it enters the measuring chamber, so that dry, purified air can be fed into the measuring chamber.

In a further development of the invention, the sensor apparatus has a filtering device with a filter housing, the condensation surface is embodied as an interior wall of the filter housing, and the outer wall of the filter housing corresponding to the interior wall is arranged to face the air-conditioned interior of the vehicle. The filtering device has a filter housing, wherein a filter is arranged in the filter housing, through which the gas provided as cleaning gas is directed. An interior wall of the filter housing designed as a condensation surface. The corresponding outer wall of the filter housing, that is to say the side of the interior wall designed as a condensation surface which faces towards the ambient atmosphere, is then arranged to face air-conditioned interior of the vehicle. The air-conditioned interior of the vehicle brings about a cooling of the outer wall of the filter housing, and therewith correspondingly a cooling of the interior wall in the form of a condensation surface. The cooling effect of the interior on the condensation surface encourages the atmospheric moisture contained in the gas which is introduced into the filter housing to condense inside the filter housing.

In a further development of the invention, the measuring chamber of the sensor apparatus is arranged to face away from the air-conditioned interior of the vehicle. The measuring chamber of the sensor apparatus and therewith the sample gas feed and sample gas discharge are arranged to face away from the air-conditioned interior of the vehicle, whereas the filter housing with condensation surface constructed therein is arranged to face towards the interior of the vehicle. Because of the arrangement facing away from the interior and the inherent heat radiated in the area of the measuring chamber by the laser light source and the ventilation system, a temperature gradient is to be expected between the condensation surface in the filter housing and the measuring chamber. This has the effect of encouraging the condensation of atmospheric moisture inside the filter housing, and condensation in the measuring chamber is effectively prevented, so that the measurements in the measuring chamber are not negatively affected by condensing atmospheric moisture.

### BRIEF DESCRIPTION OF THE DRAWINGS

In the following text, the invention will be explained in greater detail with reference to an example thereof illustrated in the drawing. In detail, the drawing shows:

The FIGURE is a schematic representation of a sensor apparatus with a measuring chamber, a ventilation system and a filter housing.

### DETAILED DESCRIPTION

The FIGURE represents a sensor apparatus 1 having a measuring chamber 2, a sample gas feed 3, a sample gas discharge 4 and a ventilation system 5. A sample gas volume to be examined, for example a sample gas volume from the atmosphere surrounding a motor vehicle, is fed to the measuring chamber 2 via the sample gas feed 3. A measuring device with a laser light source and optical components is allocated to the measuring chamber 2 for examining the sample gas volume. After the examination, the sample gas volume is directed out of the measuring chamber 2 vis the sample gas discharge 4. For this purpose, the sensor apparatus 1 includes a ventilation system 5, via which the sample gas volume, in the form of a sample gas stream, is directed through the measuring chamber 2. The sample gas discharge 3 has a connection with a cleaning gas feed 6 which is arranged in front of the ventilation system 5 from the perspective of the measuring chamber 2. A fraction of the previously examined sample gas volume is diverted from the sample gas discharge 4 into the cleaning gas feed 6 and fed to a filter housing 7. A flat filter 8, for example a filter made of nonwoven material, is arranged in the filter housing 7. The sample gas diverted from the sample gas discharge 4 through the cleaning gas feed 6 is purified by the filter 8 in the filter housing 7 by precipitation of particles present in the sample gas volume. The filter housing 7 includes a gas feed line 9 to the measuring chamber 2, through which the purified sample gas may be directed to the measuring chamber 2 as cleaning gas. The filter 8 is arranged inside the filter housing 7 in such a way that the gas volume which is fed to the filter housing 7 must pass through the filter 8 before entering the measuring chamber 2. The gas feed line 9 to the measuring chamber 2 is separated from the inlet of the cleaning gas feed 6 into the filter housing 7 by the filter 8. The condensation surface 10 is arranged in the area of the inlet of the cleaning gas feed 6 into the filter housing 7. The condensation area 10 is embodied as an interior wall of the filter housing 7. In particular, the filter housing 7 of the sensor apparatus 1 may be arranged in the interior of a motor vehicle in such manner that the condensation surface 10 of the filter housing 7 and the corresponding outer wall faces towards the air-conditioned interior of the vehicle, while the measuring chamber 2, the sample gas feed 3 and the sample gas discharge 4 face away from the air-conditioned interior of the vehicle. In the area of the measuring chamber 2, the sample gas feed 3 and the sample gas discharge 4, the ventilation unit 5 and the operation of the measuring device allocated to the measuring chamber 2 result in the radiation of inherent heat, with the result that in this area a higher temperature prevails than in the area of the condensation surface 10. This favours condensation of atmospheric moisture which is present in the sample gas volume in the area of the condensation surface 10. The flat filter 8 is arranged in the filter housing 7 at an angle to the condensation surface 10. In particular, the filter 8 may slope from downwards from the inlet of the cleaning gas feed 6 into the filter housing 7 relative to the condensation surface 10. Thus, the distance between the filter 8 and the condensation surface 10 is greater in the area of the inlet than in the area farther from the inlet. The sloping arrangement of the filter 8 means that there is more room available for collecting the condensed liquid in the area of the gas inlet.

All features presented in the preceding description and in the claims can be combined in any permutation with the features of the independent claims. The disclosure of the invention is thus not limited to the feature combinations that are described and claimed, but rather all feature combinations that a practicable within the scope of the invention are to be considered disclosed.

1. A sensor apparatus for examining a sample gas volume, particularly for capturing the particulate matter content of a sample gas volume, with at least one measuring chamber for accommodating the sample gas to be examined, with at least one sample gas feed allocated allocated to the measuring chamber and with at least one sample gas discharge allocated to the measuring chamber,
wherein
at least one cleaning gas feed is allocated to the measuring chamber, the cleaning gas feed is connected to the measuring chamber via at least one cleaning gas inlet,
a condensation area is allocated to the cleaning gas feed, and
the condensation area is arranged before the cleaning gas inlet of the cleaning gas feed in the measuring chamber.

2. The sensor apparatus according to claim 1, wherein at least one filtering device is allocated to the cleaning gas feed for purifying the gas that is directed through the cleaning gas feed, that the filtering device has a filter housing and at least one flat filter, and that the condensation area is arranged inside the filter housing.

3. The sensor apparatus according to claim 2, wherein the condensation area is designed as a condensation surface, wherein the condensation surface is embodied as an interior wall of the filter housing.

4. The sensor apparatus according to claim 2, wherein at least a first wall of the filter housing includes at least one gas feed line to the measuring chamber, at least one second wall of the filter housing has at least one inlet of the cleaning gas feed, at least one filter is arranged between the first and the second walls, and the condensation surface is separated from the gas feed line to the measuring chamber the filter.

5. The sensor apparatus according to claim 2, wherein the flat filter slopes downwards from the inlet of the cleaning gas feed to the filter housing relative to the condensation surface.

6. The sensor apparatus according to claim 2, wherein at least one filter is designed to be permeable to gas and impermeable to liquid.

7. The sensor apparatus according to claim 2, wherein the condensation surface is arranged on the side of the filter housing facing away from the measuring chamber.

8. The sensor apparatus according to claim 1, wherein at least one cleaning gas inlet in such a way that the cleaning gas stream is directed between the sample gas stream and the optical elements arranged in the measuring chamber.

9. A vehicle having a sensor apparatus according to claim 1, wherein the vehicle is equipped with an air conditioning system for regulating the atmosphere in the vehicle interior, wherein the sensor apparatus has at least one measuring chamber for accommodating a sample gas to be examined, at least one sample gas feed allocated to the measuring chamber, and at least one sample gas discharge allocated to the measuring chamber,
wherein
the sensor apparatus has a condensation surface and
the condensation surface is arranged in the area of the air-conditioned interior.

10. The vehicle according to claim 9, wherein the sensor apparatus has a filtering device with a filter housing, the condensation surface is embodied as an interior wall of the filter housing, and the outer wall of the filter housing corresponding to the interior wall is arranged to face the air-conditioned interior of the vehicle.

11. The vehicle according to claim 9, wherein the measuring chamber of the sensor apparatus is arranged to face away from the air-conditioned interior of the vehicle.
